(19) United States
(12) Patent Application Publication
(10) Pub. No.: US 2026/0369896 A1
(43) Pub. Date: Nov. 19, 2026

(54) SUB-ARRAY ANTENNA DEVICE

(71) Applicant: Fujikura Ltd., Tokyo (JP)

(72) Inventors: Shailendra Kaushal, Sakura-shi (JP); Ning Guan, Sakura-shi (JP)

(73) Assignee: Fujikura Ltd., Tokyo (JP)

(21) Appl. No.: 19/487,726

(22) PCT Filed: Jun. 19, 2024
(86) PCT No.: PCT/JP2024/022271

§ 371 Date: Nov. 25, 2025

(30) Foreign Application Priority Data
Jul. 6, 2023 (JP) 2023-111795

(51) Int. Cl. H01Q 21/29; H01Q 3/32; H01Q 21/06

(52) U.S. Cl. CPC H01Q 21/293; H01Q 3/32; H01Q 21/065

(57) ABSTRACT

A sub-army antenna device includes an antenna array formed by a plurality of sub-arrays including a plurality of radiating elements, an IC that supplies RF signals to the plurality of sub-arrays, and a substrate on which the plurality of sub-arrays and the IC are provided. The sub-array antenna device is capable of tilting a peak direction of electromagnetic waves radiated from the antenna array with respect to a direction orthogonal to the substrate.

### TECHNICAL FIELD

The present invention relates to a sub-array antenna device.

Priority is claimed on Japanese Patent Application No. 2023-111795, filed Jul. 6, 2023, the content of which is incorporated herein by reference.

### BACKGROUND ART

In the field of high-speed wireless communication, antenna devices provided to enable beam forming have been used. For example, Patent Document 1 discloses an array antenna device that forms a directional beam in which the direction can be controlled. The array antenna device is installed, for example, on a ceiling, a wall, or the like.

### CITATION LIST

### Patent Document

Patent Document 1: Japanese Unexamined Patent Application, First Publication No. 2023-39310

### SUMMARY OF INVENTION

### Technical Problem

In the array antenna device, it may be difficult to set a radiation direction of a beam with a large inclination.

An object of one aspect of the present invention is to provide a sub-array antenna device capable of setting a radiation direction of a beam with a large inclination.

### Solution to Problem

According to a first aspect of the present invention, a sub-array antenna device includes: an antenna array formed by a plurality of sub-arrays including a plurality of radiating elements; an IC configured to supply RF signals to the plurality of sub-arrays; and a substrate on which the plurality of sub-arrays and the IC are provided. A peak direction of electromagnetic waves radiated from the antenna array is capable of tilting with respect to a direction orthogonal to the substrate.

According to the first aspect of the present invention, the peak direction of the electromagnetic waves radiated from the antenna array is a direction inclined with respect to the direction orthogonal to the substrate. Therefore, the sub-array antenna device can radiate a beam inclined at a sufficient angle even when installed parallel to an installation surface. Accordingly, according to the usage environment, usage mode, and the like of the sub-array antenna device, the inclination angle of the radiation direction of the beam can be freely set over a wide range.

According to a second aspect of the present invention, in the sub-array antenna device of the first aspect, phases of RF signals supplied from the IC to two or more of the plurality of radiating elements constituting the sub-array may be different from each other.

According to a third aspect of the present invention, in the sub-array antenna device of the second aspect, the plurality of radiating elements constituting the plurality of sub-arrays may be electrically connected to the IC via a first signal line and a second signal line, and a length of the first signal line may be different from a length of the second signal line.

According to a fourth aspect of the present invention, in the sub-array antenna device of any one of the first to third aspects, the plurality of sub-arrays may include a first sub-array and a second sub-array different from the first sub-array, The first sub-array may be configured such that phases of RF signals supplied from the IC to two or more of the plurality of radiating elements are different. The second sub-array may be configured such that phases of RF signals supplied from the IC to two or more of the plurality of radiating elements are the same.

According to a fifth aspect of the present invention, in the sub-array antenna device of the fourth aspect, the plurality of sub-arrays may be arranged in a rectangular grid pattern, and a plurality of the second sub-arrays may be arranged along a diagonal line of the antenna array, which has a rectangular grid pattern.

### Advantageous Effects of Invention

One aspect of the present invention provides a sub-array antenna device capable of setting a radiation direction of a beam with a large inclination.

### BRIEF DESCRIPTION OF DRAWINGS

FIG. 1 A plan view of a sub-array antenna device according to a first embodiment.

FIG. 2 A schematic view showing a first example of a sub-array of the sub-array antenna device according to the first embodiment.

FIG. 3 A schematic view showing a second example of the sub-array of the sub-array antenna device according to the first embodiment.

FIG. 4 A schematic view showing a first installation example of the sub-array antenna device according to the first embodiment.

FIG. 5 A schematic view showing a second installation example of the sub-array antenna device according to the first embodiment.

FIG. 6 A graph showing a radiation pattern of a sub-array antenna device of Comparative Examples.

FIG. 7 A graph showing a radiation pattern of the sub-array antenna device of Examples.

FIG. 8 A plan view of a sub-array antenna device according to a second embodiment.

FIG. 9 A schematic view showing a sub-array of the sub-array antenna device according to the second embodiment.

FIG. 10 A schematic view showing an installation example of the sub-array antenna device according to the second embodiment.

FIG. 11 A plan view of a sub-array antenna device according to a third embodiment.

FIG. 12 A schematic view showing a first sub-array of the sub-array antenna device according to the third embodiment.

FIG. 13 A schematic view showing a second sub-array of the sub-array antenna device according to the third embodiment.

FIG. 14 A schematic view showing an installation example of the sub-array antenna device according to the third embodiment.

### DESCRIPTION OF EMBODIMENTS

Hereinafter, a sub-array antenna device according to embodiments of the present invention will be described with reference to the drawings.

### Sub-Array Antenna Device(First Embodiment)

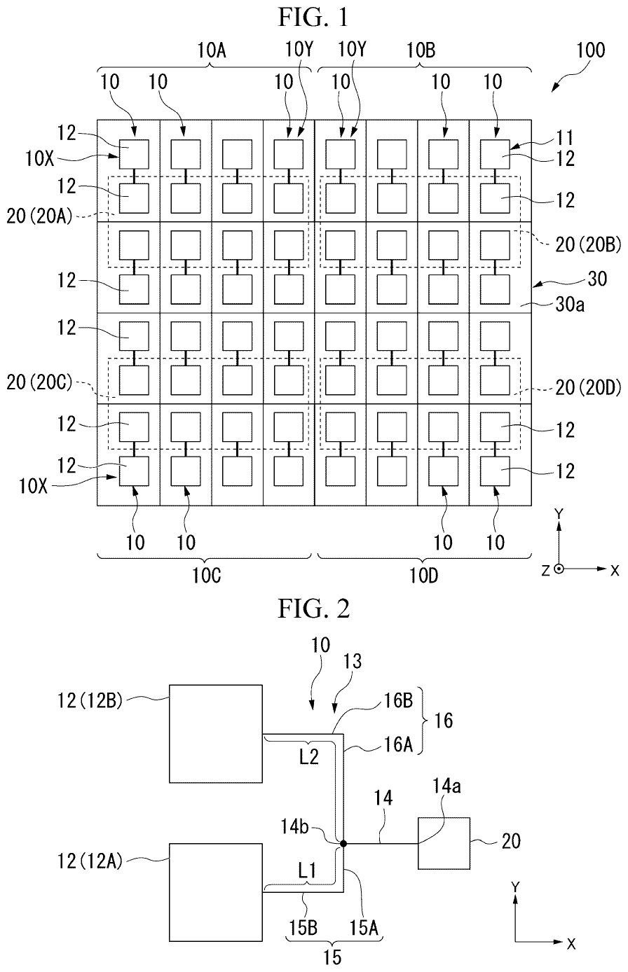

FIG. 1 is a configuration diagram of a sub-array antenna device 100 according to a first embodiment. Hereinafter, the “sub-array antenna device” may be simply referred to as an “antenna device”.

As shown in FIG. 1, the antenna device 100 includes a plurality of sub-arrays 10, a plurality of ICs 20, and a substrate 30.

In the following description, the X direction and the Y direction are parallel to a first main surface 30a of the substrate 30. The X direction and the Y direction are orthogonal to each other. The Z direction is orthogonal to the X direction and the Y direction. Plan view is seen from the Z direction. The Y direction is an example of a first direction. The X direction is an example of a second direction.

+X is one direction along the X direction and is the right side in FIG. 1. −X is the direction opposite to +X. +Y is one direction along the Y direction and is the upper side in FIG. 1. −Y is the direction opposite to +Y. +Z is one direction along the Z direction and is the direction on a front side of the paper in FIG. 1. −Z is the direction opposite to +Z.

The sub-array 10 is patterned on the first main surface 30a of the substrate 30 based on a predetermined arrangement pattern. Consequently, the sub-array 10 is provided on the substrate 30. The sub-army 10 is formed of a conductive material such as metal (copper or the like). The sub-array 10 is formed, for example, by an additive method, a subtractive method, or the like.

The plurality of sub-arrays 10 are arranged in a rectangular grid pattern (matrix pattern) along the X direction and the Y direction to constitute an antenna array 11. The plurality of sub-arrays 10 arranged in the Y direction are formed at intervals in the Y direction. The plurality of sub-arrays 10 arranged in the X direction are formed at intervals in the X direction.

In the example shown in FIG. 1, the antenna array 11 is composed of a total of 32 sub-arrays 10, with four arranged in the Y direction and eight arranged in the X direction, That is, the antenna array 11 is composed of sub-arrays 10 arranged in a rectangular grid pattern (matrix pattern) of four rows and eight columns. The four sub-arrays 10 arranged in the Y direction constitute a sub-array column 10Y. The antenna array 11 includes eight sub-array columns 10Y. The eight sub-arrays 10 arranged in the X direction constitute a sub-array row 10X. The antenna array 11 includes four sub-array rows 10X.

The plurality of sub-arrays 10 include a first sub-array group 10A, a second sub-array group 10B, a third sub-array group 10C, and a fourth sub-array group 10D.

The first sub-array group 10A includes a plurality of sub-arrays 10 located on the +Y side with respect to the center and on the −X side with respect to the center. That is, the first sub-array group 10A is composed of eight sub-arrays 10 included in two sub-array rows 10X from the top and four sub-array columns 10Y from the left in FIG. 1.

The second sub-array group IOB includes a plurality of sub-arrays 10 located on the +Y side with respect to the center and on the +X side with respect to the center. That is, the second sub-array group 10B is composed of eight sub-arrays 10 included in two sub-array rows 10X from the top and four sub-array columns 10Y from the right in FIG. 1.

The third sub-array group 10C includes a plurality of sub-arrays 10 located on the −Y side with respect to the center and on the −X side with respect to the center. That is, the third sub array group 10C is composed of eight sub-arrays 10 included in two sub-array rows 10X from the bottom and four sub-array columns 10Y from the left in FIG. 1.

The fourth sub-array group 10D includes a plurality of sub-arrays 10 located on the −Y side with respect to the center and on the +X side with respect to the center. That is, in FIG. 1, the fourth sub-array group 10D is composed of eight sub-arrays 10 included in two sub-array rows 10X from the bottom and four sub-array columns 10Y from the right.

The IC 20 is an integrated circuit (IC) that processes a radio frequency (RF) signal. The IC 20 is mounted, for example, on a surface of the substrate 30 opposite to the first main surface 30a. Consequently, the IC 20 is provided on the substrate 30. The IC 20 supplies an RF signal to a radiating element 12 via a signal line 13 (refer to FIG. 2). The IC 20 is, for example, a beam forming IC (BFIC).

In the example shown in FIG. 1, the antenna device 100 includes four ICs 20. The four ICs 20 are arranged in a rectangular grid pattern (matrix pattern), with two arranged in the Y direction and two arranged in the X direction. The four ICs 20 are first to fourth ICs 20A to 20D. The first IC 20A is electrically connected to each of the plurality of sub-arrays 10 included in the first sub-array group 10A. The second IC 20B is electrically connected to each of the plurality of sub-arrays 10 included in the second sub-array group 10B. The third IC 20C is electrically connected to each of the plurality of sub-arrays 10 included in the third sub-array group 10C. The fourth IC 20D is electrically connected to each of the plurality of sub-arrays 10 included in the fourth sub-array group 10D.

FIG. 2 is a schematic view showing a first example of the sub-array 10. As shown in FIG. 2, in this example, the sub-array 10 includes two radiating elements 12 arranged in the Y direction and the signal line 13.

The radiating element 12 is formed in a rectangular shape. The radiating element 12 includes a pair of sides along the X direction and a pair of sides along the Y direction. The two radiating elements 12 constituting the sub-array 10 are formed adjacent to each other at an interval in the Y direction. One of the two radiating elements 12 is a first radiating element 12A. The other of the two radiating elements 12 is a second radiating element 12B. The second radiating element 12B is located on the +Y side with respect to the first radiating element 12A.

The signal line 13 includes a main line 14, a first branch line (first signal line) 15, and a second branch line (second signal line) 16. A proximal end 14a (first end) of the main line 14 is electrically connected to the IC 20. The first branch line 15 and the second branch line 16 are branch lines that branch from a distal end 14b (a second end which is an end opposite to the first end) of the main line 14. The distal end 14b of the main line 14 is not located at a midpoint between the first radiating element 12A and the second radiating element 12B in the Y direction. In the example shown in FIG. 2, the distal end 14b of the main line 14 is located on the −Y side with respect to the midpoint between the first radiating element 12A and the second radiating element 12B.

The first branch line 15 extends from the distal end 14b of the main line 14 and reaches the first radiating element 12A. The first radiating element 12A is electrically connected to the IC 20 via the main line 14 and the first branch line 15.

The first branch line 15 has an L-shape and includes a first line 15A along the Y direction and a second line 15B along the X direction. The first line 15A extends linearly from the distal end 14b of the main line 14 toward the −Y side. The second line 15B extends linearly from a distal end of the first line 15A on the −Y side toward the −X side. L1 is a length of the first branch line 15.

The second branch line 16 extends from the distal end 14b of the main line 14 and reaches the second radiating element 12B. The second radiating element 12B is electrically connected to the IC 20 via the main line 14 and the second branch line 16.

The second branch line 16 has an L-shape and includes a first line 16A along the Y direction and a second line 16B along the X direction. The first line 16A extends linearly from the distal end 14b of the main line 14 toward the +Y side, The second line 16B extends linearly from a distal end of the first line 16A on the +Y side toward the −X side. L2 is a length of the second branch line 16.

The second branch line 16 is longer than the first branch line 15. That is, the length L2>the length L1. Therefore, the signal line from the IC 20 to the second radiating element 12B is longer than the signal line from the IC 20 to the first radiating element 12A. Consequently, the phase of the RF signal supplied from the IC 20 to the first radiating element 12A is different from the phase of the RF signal supplied from the IC 20 to the second radiating element 12B. In other words, the phases of the RF signals supplied from the IC 20 to the two radiating elements 12 are different from each other.

The difference in length (L2−L1) between the first branch line 15 and the second branch line 16 can be determined, for example, such that a phase difference corresponding to ⅛ to ½ (for example, ¼ to ½) of the design wavelength of the RF signal is generated. The difference between the phase of the RF signal supplied from the IC 20 to the first radiating element 12A and the phase of the RF signal supplied from the IC 20 to the second radiating element 12B is, for example, 45 degrees to 180 degrees (preferably 60 degrees to 180 degrees). In other words, the difference in phase of the RF signals supplied from the IC 20 to the two radiating elements 12 (12A and 12B) is, for example, 45 degrees to 180 degrees (preferably 60 degrees to 180 degrees).

The radiating elements 12 (12A and 12B) receive the RF signals supplied from the signal line 13 and radiate electromagnetic waves.

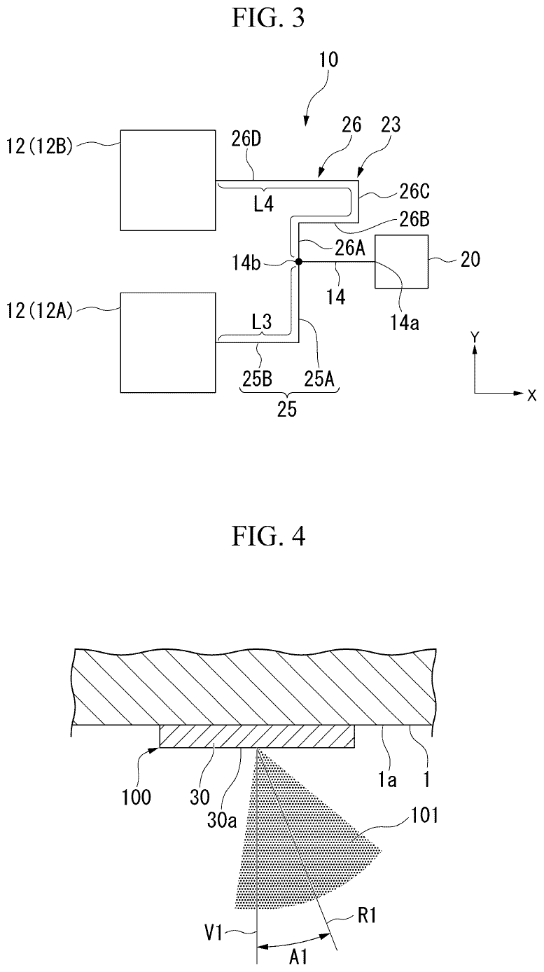

FIG. 3 is a schematic view showing a second example of the sub-array 10. As shown in FIG. 3. in this example, the sub-array 10 includes two radiating elements 12 arranged in the Y direction and a signal line 23. The same reference numerals are assigned to the common configurations to the first example (refer to FIG. 2), and the description thereof will be omitted.

The signal line 23 includes the main line 14, a first branch line (first signal line) 25, and a second branch line (second signal line) 26. The first branch line 25 and the second branch line 26 are branch lines that branch from the distal end 14b (the second end which is the end opposite to the first end) of the main line 14. The distal end 14b of the main line 14 is located at the midpoint between the first radiating element 12A and the second radiating element 12B in the Y direction.

The first branch line 25 extends from the distal end 14b of the main line 14 and reaches the first radiating element 12A. The first radiating element 12A is electrically connected to the IC 20 via the main line 14 and the first branch line 25.

The first branch line 25 has an L-shape and includes a first line 25A along the Y direction and a second line 25B along the X direction. The first line 25A linearly extends from the distal end 14b of the main line 14 toward the −Y side. The second line 25B extends linearly from a distal end of the first line 25A on the −Y side toward the −X side. L3 is a length of the first branch line 25.

The second branch line 26 extends from the distal end 14b of the main line 14 and reaches the second radiating element 12B. The second radiating element 12B is electrically connected to the IC 20 via the main line 14 and the second branch line 26.

The second branch line 26 includes a first line 26A, a second line 26B, a third line 26C, and a fourth line 26D. The first line 26A extends linearly from the distal end 14b of the main line 14 toward the +Y side. The second line 26B extends linearly from a distal end of the first line 26A on the +Y side toward the +X side. The third line 26C extends linearly from a distal end of the second line 26B on the +X side toward the +Y side. The fourth line 26D extends linearly from a distal end of the third line 26C on the +Y side toward the −X side. L4 is a length of the second branch line 26.

The second branch line 26 is longer than the first branch line 25. That is, the length L4>the length L3. Therefore, the signal line from the IC 20 to the second radiating element 12B is longer than the signal line from the IC 20 to the first radiating element 12A. Consequently, the phase of the RF signal supplied from the IC 20 to the first radiating element 12A is different from the phase of the RF signal supplied from the IC 20 to the second radiating element 12B. In other words, the phases of the RF signals supplied from the IC 20 to the two radiating elements 12 are different from each other.

The difference in length (L4−L3) between the first branch line 25 and the second branch fine 26 can be determined, for example, such that a phase difference corresponding to ⅛ to ½ (for example, ¼ to ½) of the design wavelength of the RF signal is generated. The difference between the phase of the RF signal supplied from the IC 20 to the first radiating element 12A and the phase of the RF signal supplied from the IC 20 to the second radiating element 12B is, for example, 45 degrees to 180 degrees (preferably 60 degrees to 180 degrees). In other words, the difference in phase of the RF signals supplied from the IC 20 to the two radiating elements 12 (12A and 12B) is, for example, 45 degrees to 180 degrees (preferably 60 degrees to 180 degrees).

The radiating elements 12 (12A and 12B) receive the RF signals supplied from the signal line 23 and radiate electromagnetic waves.

FIG. 4 is a schematic view showing a first installation example of the antenna device 100. FIG. 4 shows an example in which the antenna device 100 is installed on a ceiling. As shown in FIG. 4, the antenna device 100 is installed on a top surface la (installation surface) of a ceiling 1. The top surface 1a is, for example, a horizontal surface. The substrate 30 is oriented parallel to the top surface 1a. V1 is a perpendicular line orthogonal to the top surface 1a and the substrate 30 (first main surface 30a). Reference numeral 101 is electromagnetic waves radiated from the antenna army 11. R1 indicates a peak direction of the electromagnetic waves 101 (a direction in which the gain is highest). The peak direction of the electromagnetic waves 101 is, for example, a direction of a central axis of the electromagnetic waves 101.

In the antenna device 100, the phases of the RF signals supplied to the two radiating elements 12 constituting the sub-array 10 are different from each other (refer to FIGS. 2 and 3). Therefore, the peak direction R1 of the electromagnetic waves 101 radiated from the radiating elements 12 is a direction inclined with respect to the perpendicular line V1. An inclination angle A1 of the peak direction R1 with respect to the perpendicular line V1 is, for example, greater than 0 degrees and 60 degrees or less. The inclination angle A1 may be 10 degrees or greater and 50 degrees or less.

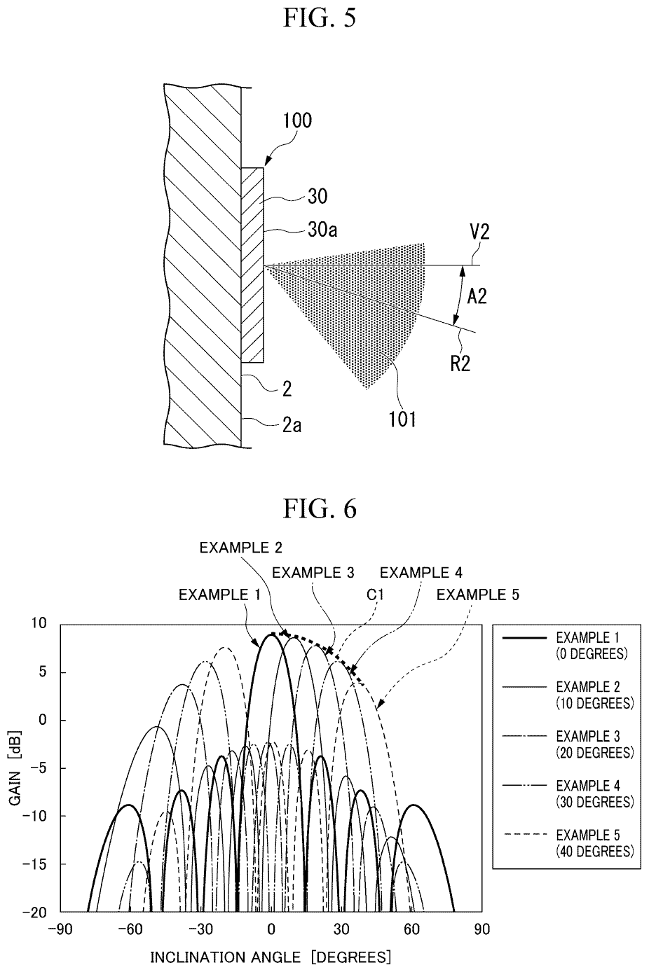

FIG. 5 is a schematic view showing a second installation example of the antenna device 100. FIG. 5 shows an example in which the antenna device 100 is installed on a wall. As shown in FIG. 5, the antenna device 100 is installed on a wall surface 2a (installation surface) of a wall 2. The wall surface 2a is perpendicular to, for example, a horizontal surface. The substrate 30 is oriented parallel to the wall surface 2a. V2 is a perpendicular line orthogonal to the wall surface 2a and the substrate 30. R2 indicates the peak direction of the electromagnetic waves 101 (the direction in which the gain is highest).

In the antenna device 100, the phases of the RF signals supplied to the two radiating elements 12 constituting the sub-array 10 are different from each other (refer to FIGS. 2 and 3). Therefore, the peak direction R2 of the electromagnetic waves 101 radiated from the radiating elements 12 is a direction inclined with respect to the perpendicular line V2. An inclination angle A2 of the peak direction R2 with respect to the perpendicular line V 2 is, for example, greater than 0 degrees and 60 degrees or less. The inclination angle A2 may be 10 degrees or greater and 50 degrees or less.

### Comparative Examples

In order to clarify the effects of the antenna device 100, an antenna device according to a comparative embodiment is assumed. In the antenna device of the comparative embodiment, the lengths of the signal lines extending from the IC to the two radiating elements constituting the sub-array 10 are equal to each other. Therefore, the RF signals supplied from the IC to the two radiating elements are in the same phase.

The radiation pattern of the antenna device of the comparative embodiment was acquired. The inclination angles of the peak direction of the electromagnetic waves with respect to the perpendicular line perpendicular to the installation surface and the substrate were set to 0 degrees (Example 1), 10 degrees (Example 2), 20 degrees (Example 3), 30 degrees (Example 4), and 40 degrees (Example 5). The results are shown in FIG. 6. FIG. 6 is a graph showing the radiation pattern of the antenna device according to the comparative embodiment. C1 shown in FIG. 6 is a trend line passing through the peaks of the radiation patterns of Examples 1 to 5.

### EXAMPLES

In the antenna device 100 shown in FIG. 1, the lengths of the signal lines extending from the IC 20 to the two radiating elements 12 (12A and 12B) constituting the sub-array 10 are different from each other. In this Example, a difference in phase of the RF signals supplied from the IC 20 to the two radiating elements 12 (12A and 12B) is 180 degrees.

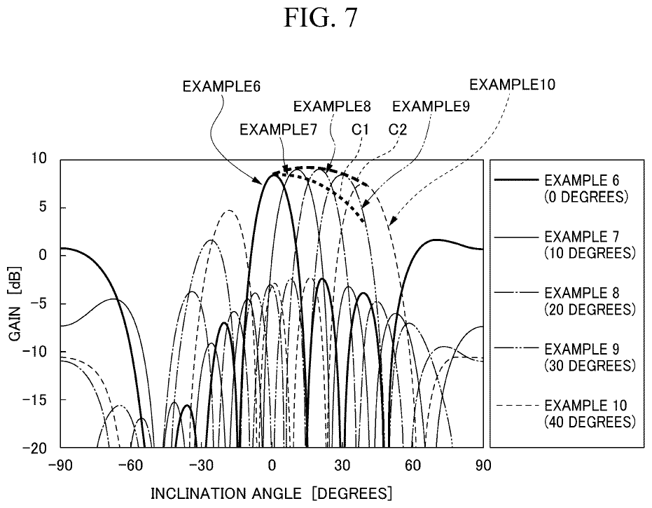

The radiation pattern of the antenna device 100 was acquired. The inclination angles of the peak direction of the electromagnetic waves with respect to the perpendicular line perpendicular to the installation surface and the substrate 30 were set to 0 degrees (Example 6), 10 degrees (Example 7), 20 degrees (Example 8), 30 degrees (Example 9), and 40 degrees (Example 10). The results are shown in FIG. 7. FIG. 7 is a graph showing the radiation pattern of the antenna device 100. C2 shown in FIG. 7 is a trend line passing through the peaks of the radiation patterns of Examples 6 to 10. In FIG. 7, for comparison, the trend line C1 of Comparative Examples is also shown.

As shown in FIG. 6, in Comparative Examples, the radiation patterns exhibit a decrease in gain as the inclination angle of the peak direction of the electromagnetic waves increases (refer to the trend line C1).

On the other hand, in Examples shown in FIG. 7, the radiation patterns did not exhibit a decrease in gain, even when the inclination angle of the peak direction of the electromagnetic waves increased, as compared with the radiation patterns in Comparative Examples (refer to the trend line C2).

From this result, it was found that in the antenna device 100, the inclination angles of the peak directions R1 and R2 can be set to be large while suppressing a decrease in gain.

The antenna device 100 can be used to transmit and receive electromagnetic waves. The antenna device 100 may be used for one of transmission and reception. The antenna device 100 can be used as an antenna device for communication in the field of Internet of Things (IoT) or for high-speed wireless communication such as Wireless Gigabit (WiGig).

### Effects Achieved by Sub-Array Antenna Device of First Embodiment

The antenna device 100 of the present embodiment includes the plurality of sub-arrays 10, the IC 20 that supplies RF signals to the sub-arrays 10, and the substrate 30 on which the sub-arrays 10 and the IC 20 are provided. The peak directions R1 and R2 of the electromagnetic waves 101 radiated from the antenna array 11 are directions inclined with respect to the perpendicular lines V1 and V2 (refer to FIGS. 4 and 5). Therefore, the antenna device 100 can radiate a beam inclined at a sufficient angle even when installed parallel to the installation surface. Accordingly, according to the usage environment, usage mode, and the like of the antenna device 100, the inclination angle of the radiation direction of the beam can be freely set over a wide range.

In the antenna device 100, the peak directions R1 and R2 of the electromagnetic waves 101 are directions inclined with respect to the perpendicular lines V1 and V2 due to the difference in phase of the RF signals supplied to the two radiating elements 12 constituting the sub-array 10 (refer to FIGS. 4 and 5), Therefore, by adjusting the phases of the RF signals supplied to the two radiating elements 12 constituting the sub-array 10, the peak directions R1 and R2 of the electromagnetic waves 101 can be freely set. Accordingly, the setting of the peak directions RI and R2 of the electromagnetic waves 101 becomes easy.

In the antenna device 100, the phases of the RF signals supplied to the two radiating elements 12 constituting the sub-array are different from each other due to the difference in length of the signal lines to the two radiating elements 12. According to this configuration, the phases of the RF signals supplied to the two radiating elements 12 can be adjusted with a simple structure. Accordingly, it is possible to achieve size reduction and cost reduction of the antenna device 100.

### Sub-Array Antenna Device (Second Embodiment)

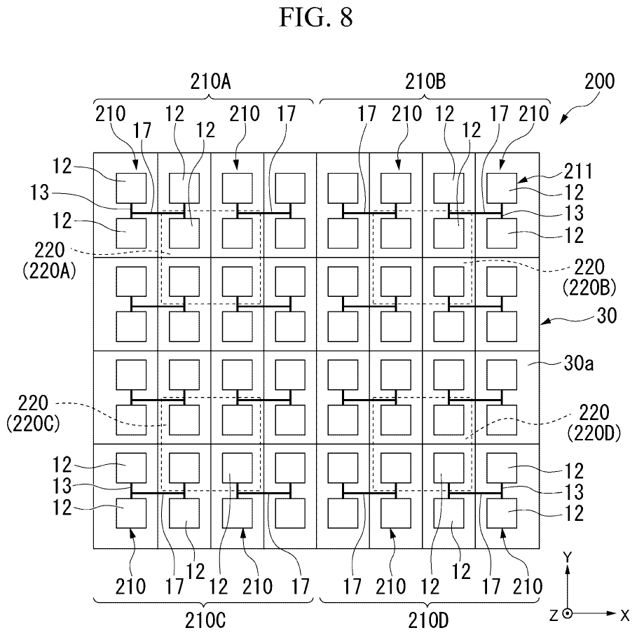

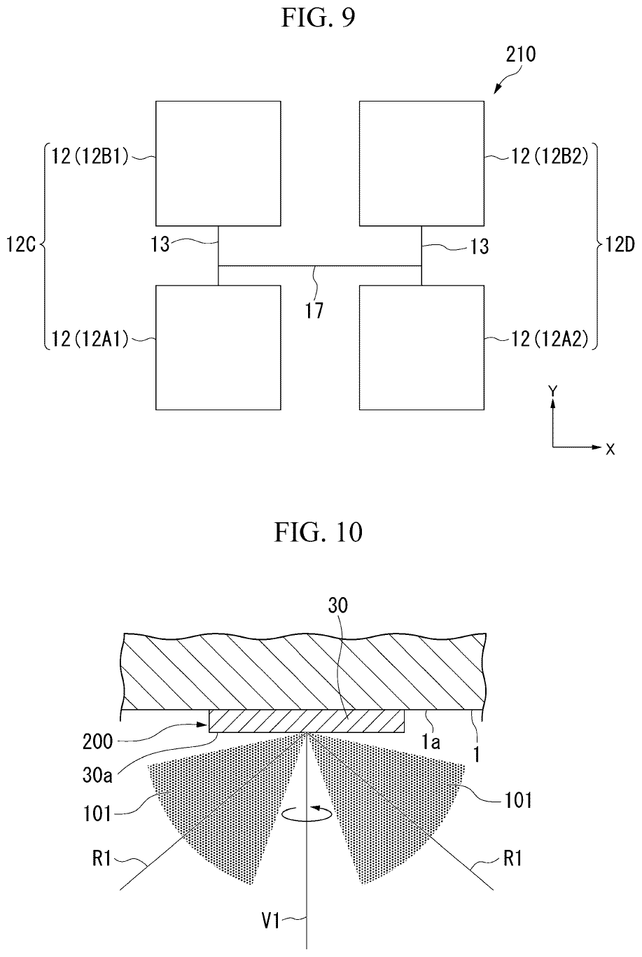

FIG. 8 is a configuration diagram of an antenna device 200 according to a second embodiment. FIG. 9 is a schematic view showing a sub-array 210. The same reference numerals are assigned to the common configurations to the antenna device 100 shown in FIG. 1, and the description thereof will be omitted.

As shown in FIG. 8, the antenna device 200 includes a plurality of sub-arrays 210, a plurality of ICs 220, and the substrate 30.

As shown in FIGS. 8 and 9, the sub-array 210 has a configuration in which two sub-arrays 10 (refer to FIG. 1) adjacent to each other in the X direction in the first embodiment are electrically connected to each other.

Specifically, in FIG. 8, the sub-array 10 (refer to FIG. 1) in the first column from the left in each row and the sub-array 10 (refer to FIG. 1) in the second column in each row are electrically connected to each other via a connection line 17 between the signal lines 13. Consequently, the sub-array 210 is formed.

Similarly, each of the sub-arrays 10 (refer to FIG. 1) in the third, fifth, and seventh columns from the left in each row and the sub-arrays 10 adjacent thereto on the +X side in each row (that is, each of the sub-arrays 10 in the fourth, sixth, and eighth columns) (refer to FIG. 1) are electrically connected to each other via the connection line 17 between the signal lines 13. As a result, the sub-array 210 is formed.

The plurality of sub-arrays 210 are arranged in a rectangular grid pattern (matrix pattern) along the X direction and the Y direction to constitute an antenna array 211. The antenna array 211 is composed of a total of 16 sub-arrays 210, with four arranged in the Y direction and four arranged in the X direction.

The plurality of sub-arrays 210 include a first sub-array group 210A, a second sub-array group 210B, a third sub-array group 210C, and a fourth sub-array group 210D.

The first sub-array group 210A includes four sub-arrays 210 located on the +Y side with respect to the center and on the −X side with respect to the center. The second sub-array group 210B includes four sub-arrays 210 located on the +Y side with respect to the center and on the +X side with respect to the center. The third sub-array group 210C includes four sub-arrays 210 located on the −Y side with respect to the center and on the −X side with respect to the center. The fourth sub-array group 210D includes four sub-arrays 210 located on the −Y side with respect to the center and on the +X side with respect to the center.

In the example shown in FIG. 8. the antenna device 200 includes four ICs 220. The four ICs 220 are arranged in a rectangular grid pattern (matrix pattern), with two arranged in the Y direction and two arranged in the X direction. The four ICs 220 are first to fourth ICs 220A to 220D.

The first IC 220A is electrically connected to each of the plurality of sub-arrays 210 included in the first sub-array group 210A. The second IC 220B is electrically connected to each of the plurality of sub-arrays 210 included in the second sub-array group 210B. The third IC 220C is electrically connected to each of the plurality of sub-arrays 210 included in the third sub-array group 210C. The fourth IC 220D is electrically connected to each of the plurality of sub-arrays 210 included in the fourth sub-array group 210D.

As shown in FIG. 9, the sub-array 210 includes a first radiating element group 12C and a second radiating element group 12D. The first radiating element group 12C and the second radiating element group 12D are adjacent to each other in the X direction, The first radiating clement group 12C includes two radiating elements 12 (a first radiating element 12A1 and a second radiating element 12B1) arranged in the Y direction. The second radiating element group 12D includes two radiating elements 12 Ca first radiating element 1242 and a second radiating element 12B2) arranged in the Y direction.

In the first radiating element group 12C, the lengths of a signal line from the IC 220 (refer to FIG. 8) to the first radiating element 12A1 and a signal line from the IC 220 (refer to FIG. 8) to the second radiating element 12B1 are different from each other. Consequently, the phases of the RF signals supplied from the IC 220 to the two radiating elements 12A1 and 12B1 are different from each other. The difference in phase of the RF signals supplied from the IC 220 to the two radiating elements 12A1 and 12B1 is, for example, 45 degrees to 180 degrees (preferably 60 degrees to 180 degrees).

In the second radiating element group 12D, the lengths of a signal line from the IC 220 (refer to FIG. 8) to the first radiating element 12A2 and a signal line from the IC 220 (refer to FIG. 8) to the second radiating element 12B2 are different from each other. Consequently, the phases of the RF signals supplied from the IC 220 to the two radiating elements 12A2 and 12B2 are different from each other. The difference in phase of the RF signals supplied from the IC 220 to the two radiating elements 12A2 and 12B2 is, for example, 45 degrees to 180 degrees (preferably 60 degrees to 180 degrees).

The phases of the RF signals supplied to the first radiating elements 12A1 and 12A2 adjacent to each other in the X direction are different from each other. The difference in phase of the RF signals supplied from the IC 220 to the two radiating elements 12A1 and 12A2 is, for example, 45 degrees to 180 degrees (preferably 60 degrees to 180 degrees).

The phases of the RF signals supplied to the second radiating elements 12B1 and 12B2 adjacent to each other in the X direction are different from each other. The difference in phase of the RF signals supplied from the IC 220 to the two radiating elements 12B1 and 12B2 is, for example, 45 degrees to 180 degrees (preferably 60 degrees to 180 degrees).

Specifically, an example can be given in which the difference in phase of the RF signals supplied to the two radiating elements 12A1 and 12B1 in the first radiating element group 12C is 180 degrees, and the difference in phase of the RF signals supplied to the two radiating elements 12A2 and 12B2 in the second radiating element group 12D is 180 degrees.

The difference in phase of the RF signals supplied to the first radiating elements 12A1 and 12A2 adjacent to each other in the X direction is, for example, 180 degrees. The difference in phase of the RF signals supplied to the second radiating elements 12B1 and 12B2 adjacent to each other in the X direction is, for example, 180 degrees.

FIG. 10 is a schematic view showing an installation example of the antenna device 200. In the example shown in FIG. 10, the antenna device 200 is installed on the top surface 1a (installation surface) of the ceiling 1.

As shown in FIG. 10, the antenna device 200 can radiate the electromagnetic waves 101 in a plurality of directions.

The antenna device 200 of the present embodiment exhibits the same effect as the antenna device 100 (refer to FIG. 1) of the first embodiment.

Further, the antenna device 200 has an advantage in that the antenna device 200 can radiate the electromagnetic waves 101 in multiple directions because the sub-array 210 includes the plurality of radiating element groups 12C and 12D.

### Sub-Array Antenna Device (Third Embodiment)

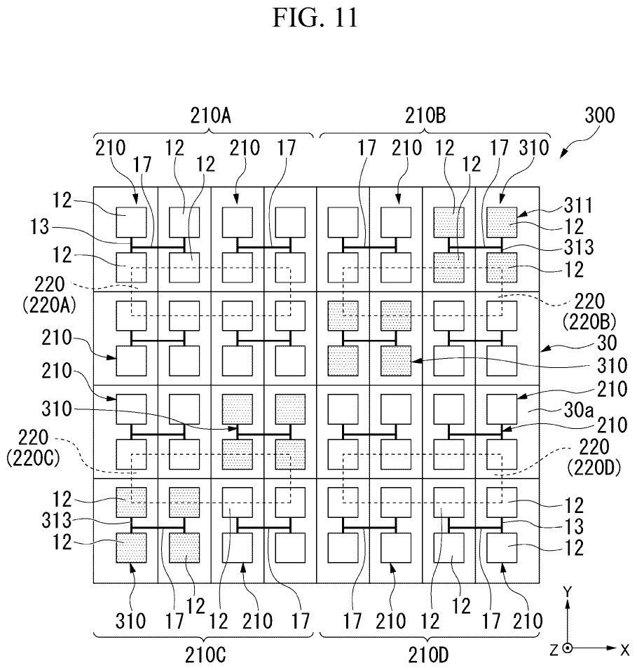

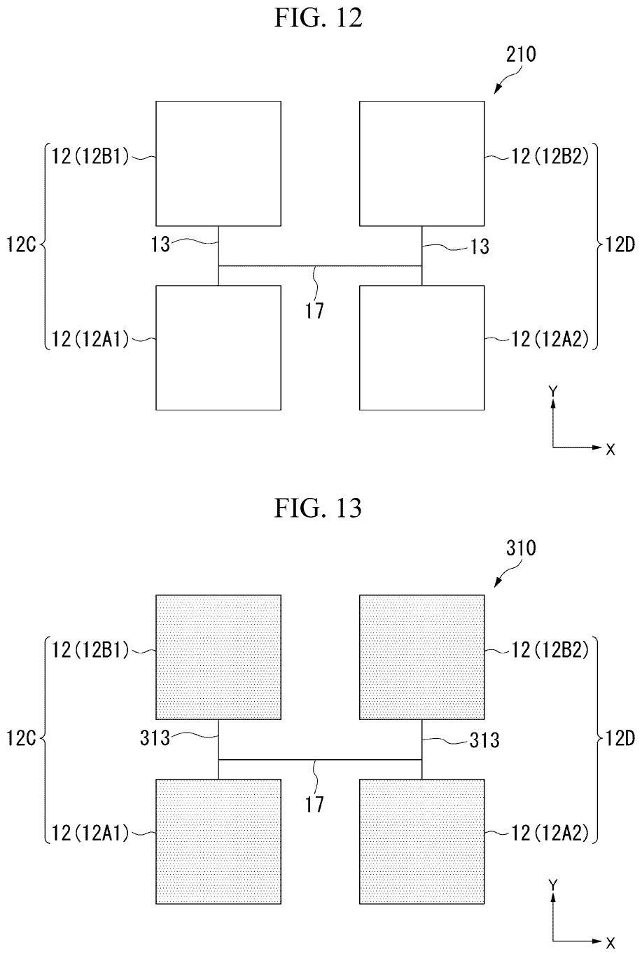

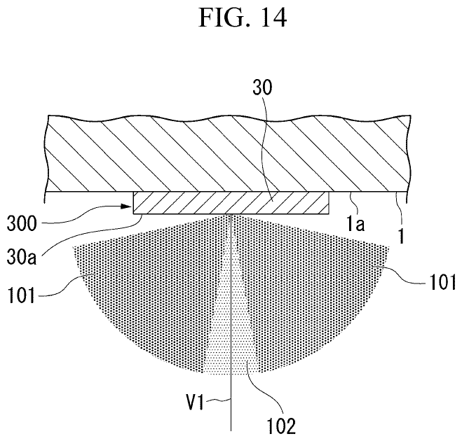

FIG. 11 is a configuration diagram of an antenna device 300 according to a third embodiment. FIG. 12 is a schematic view showing a first sub-army 210. FIG. 13 is a schematic view showing a second sub-array 310. FIG. 14 is a schematic view showing an installation example of the antenna device 300, The same reference numerals are assigned to the common configurations to other embodiments, and the description thereof will be omitted.

As shown in FIG. 11, the antenna device 300 includes a plurality of first sub-arrays 210, a plurality of second sub-arrays 310, a plurality of ICs 220, and the substrate 30.

As shown in FIG. 12, the first sub-array 210 has the same configuration as the sub-array 210 (refer to FIG. 9) in the second embodiment.

As shown in FIG. 13, in the second sub-array 310, the IC 220 (refer to FIG. 11) supplies the RF signal to the radiating element 12 via a signal line 313.

In the second sub-array 310. in the first radiating element group 12C, the lengths of a signal line from the IC 220 (refer to FIG. 11) to the first radiating element 12A1 and a signal line from the IC 220 to the second radiating element 12B1 are the same, As a result, the phases of the RF signals supplied from the IC 220 to the two radiating elements 12A1 and 12B1 are the same.

In the second sub-array 310, in the second radiating element group 12D, the lengths of a signal line from the IC 220 (refer to FIG. 11) to the first radiating element 12A2 and a signal line from the IC 220 to the second radiating element 12B2 are the same. As a result, the phases of the RF signals supplied from the IC 220 to the two radiating elements 12A2 and 12B2 are the same.

As shown in FIG. 11, the plurality of first sub-arrays 210 and the plurality of second sub-arrays 310 are arranged in a rectangular grid pattern (matrix pattern) in the X direction and the Y direction as a whole to constitute an antenna array 311. The antenna array 311 is composed of a total of 16 sub-arrays 210 and 310, with four arranged in the Y direction and four arranged in the X direction.

Among the 16 sub-arrays constituting the antenna array 311, four sub-arrays arranged along one diagonal line are the second sub-arrays 310. Specifically, in FIG. 11, the sub-array in the first column from the right and the first row from the top is the second sub-array 310. The sub-array in the second column from the right and the second row from the top is also the second sub-array 310. The sub-array in the third column from the right and the third row from the top is also the second sub-array 310. The sub-array in the fourth column from the right and the fourth row from the top is also the second sub-array 310. The remaining 12 sub-arrays are the first sub-arrays 210.

In the antenna device 300, a plurality of sub-arrays constituting the antenna array 311 include the first sub-arrays 210 and the second sub-arrays 310.

In the first sub-array 210, the phases of the RF signals supplied from the IC 220 to the plurality of radiating elements 12 are different from each other.

In the second sub-array 310, the phases of the RF signals supplied from the IC 220 to the plurality of radiating elements 12 are the same.

FIG. 14 is a schematic view showing an installation example of the antenna device 300. In the example shown in FIG. 14, the antenna device 300 is installed on the top surface la (installation surface) of the ceiling 1.

As shown in FIG. 14, in the antenna device 300, the electromagnetic waves 101 are radiated by the 12 first sub-arrays 210. Electromagnetic waves 102 are radiated by the four second sub-arrays 310.

The antenna device 300 of the present embodiment exhibits the same effect as the antenna device 200 (refer to FIG. 8) of the second embodiment.

Further, the antenna device 300 can also radiate electromagnetic waves in the direction of the perpendicular line V1 using the second sub-arrays 310, thereby radiating electromagnetic waves over a wide range.

The second sub-arrays 310 are arranged in a single row along a diagonal line of the antenna array 311, which has a rectangular grid pattern. Therefore, the second sub-arrays 310 are disposed to be rotationally symmetrical with respect to the center of the antenna array 311. In this manner, since the second sub-arrays 310 are disposed without bias in the antenna array 311, the bias in the radiation direction of the electromagnetic waves 102 from the second sub-arrays 310 can be reduced.

The technical scope of the present invention is not limited to the above embodiments, and various modifications can be made without departing from the gist of the present invention. For example, in the antenna devices 100 and 200 shown in FIGS. 1 and 8. the number of radiating elements 12 constituting the sub-arrays 10 and 210 is two or four, but the number of radiating elements constituting the sub-array is not limited thereto. The number of radiating elements constituting the sub-array may be any number of two or more.

In a case where the number of radiating elements constituting the sub-array is three or more, the phases of the RF signals supplied from the IC to the radiating elements may be different from each other for two or more of the plurality of radiating elements.

As shown in FIGS. 2 and 3, in the antenna device 100, the phases of the RF signals supplied to the two radiating elements 12 are different from each other due to differences in the lengths of the signal lines. However, the method for making the phases of the RF signals supplied to the two radiating elements 12 different is not limited thereto. For example, a device (for example, a phase shifter) that changes the phase of the RF signal may be provided in only one of the path from the IC to the first radiating element or the path from the IC to the second radiating element. As a result, even in a case where the lengths of the signal lines from the IC to the two radiating elements are equal to each other, the phases of the RF signals supplied to the two radiating elements can be made different from each other.

In addition, within a scope not departing from the gist of the present invention. the components in the above-described embodiments can be replaced as appropriate with known components, and the above-described embodiments and modification examples may be combined as appropriate.

### INDUSTRIAL APPLICABILITY One aspect of the present invention provides a sub-array antenna device capable of setting a radiation direction of a beam with a large inclination.

### REFERENCE SIGNS LIST

1a Top surface (installation surface)
2a Wall surface (installation surface)
10, 210 Sub-array
11, 211, 311 Antenna array
12 Radiating clement
12A, 12A1, 12A2 First radiating element (radiating element)
12B, 12B1, 12B2 Second radiating element (radiating clement)
13, 23 Signal line
20, 220 IC
30 Substrate
100, 200, 300 Antenna device (sub-array antenna device)
101, 102 Electromagnetic waves
27
210 First sub-array
310 Second sub-array
R1 Peak direction of electromagnetic waves
V1 Perpendicular line orthogonal to substrate

1. A sub-array antenna device comprising:
an antenna array formed by a plurality of sub-arrays including a plurality of radiating elements;
an IC configured to supply RF signals to the plurality of sub-arrays; and
a substrate on which the plurality of sub-arrays and the IC are provided,
wherein a peak direction of electromagnetic waves radiated from the antenna array is capable of tilting with respect to a direction orthogonal to the substrate.

2. The sub-array antenna device according to claim 1,
wherein phases of RF signals supplied from the IC to two or more of the plurality of radiating elements constituting the sub-array are different from each other.

3. The sub-array antenna device according to claim 2,
wherein the plurality of radiating elements constituting the plurality of sub-arrays are electrically connected to the IC via a first signal line and a second signal line, and
a length of the first signal line is different from a length of the second signal line.

4. The sub-array antenna device according to claim 1,
wherein the plurality of sub-arrays include a first sub-array and a second sub-array different from the first sub-array,
the first sub-array is configured such that phases of RF signals supplied from the IC to two or more of the plurality of radiating elements are different, and
the second sub-array is configured such that phases of RF signals supplied from the IC to two or more of the plurality of radiating elements are the same.

5. The sub-array antenna device according to claim 4,
wherein the plurality of sub-arrays are arranged in a rectangular grid pattern, and
a plurality of the second sub-arrays are arranged along a diagonal line of the antenna array, which has a rectangular grid pattern.

6. The sub-array antenna device according to claim 2,
wherein the plurality of sub-arrays include a first sub-array and a second sub-array different from the first sub-array,
the first sub-array is configured such that phases of RF signals supplied from the IC to two or more of the plurality of radiating elements are different, and
the second sub-array is configured such that phases of RF signals supplied from the IC to two or more of the plurality of radiating elements are the same.

7. The sub-array antenna device according to claim 3,
wherein the plurality of sub-arrays include a first sub-array and a second sub-array different from the first sub-array,
the first sub-array is configured such that phases of RF signals supplied from the IC to two or more of the plurality of radiating elements are different, and the second sub-array is configured such that phases of RF signals supplied from the IC to two or more of the plurality of radiating elements are the same.
